(19) United States
(12) Patent Application Publication
(10) Pub. No.: US 2023/0111308 A1
(43) Pub. Date: Apr. 13, 2023

(54) A SCREEN FOR GREENHOUSE OR FOR OUTDOOR CULTIVATIONS

(71) Applicant: INFRASCREEN SA, Neuchâtel (CH)

(72) Inventor: Benoît De Combaud, Buchillon (CH)

(21) Appl. No.: 17/904,819

(22) PCT Filed: Feb. 24, 2021
(86) PCT No.: PCT/IB2021/051557

§ 371 Date: Aug. 23, 2022

(30) Foreign Application Priority Data
Feb. 24, 2020 (CH) 00217/20

(51) Int. Cl. A01G 9/14; A01G 9/22

(52) U.S. Cl. CPC A01G 9/1438; A01G 9/22; A01G 2009/1453

(57) ABSTRACT

A screen for greenhouse or for outdoor cultivations is described. A foldable screen for greenhouse or for outdoor cultivations, comprising: a canvas, a substrate on one side of the canvas, arranged for preventing convective heat transfer through the screen; at least one stack of films mounted on or adhering to said substrate, wherein said stack of film is adapted to:—transmit at least 80% of radiations within the range from 400 nm to 2,000 nm when said radiations hit said film at normal incidence,—reject at least 70%, preferably at least 80% of radiations at normal incidence within the range from 3,000 nm to 35,000 nm.

### CROSS-REFERENCE

The present Application for Patent claims priority to International Patent Application No. PCT/IB2021/051557 by De Combaud, entitled “A SCREEN FOR GREENHOUSE OR FOR OUTDOOR CULTIVATIONS”, filed Feb. 24, 2021, which claims priority to Swiss Patent Application No. 00217/20 by De Combaud, entitled “A SCREEN FOR GREENHOUSE OR FOR OUTDOOR CULTIVATIONS”, filed Feb. 24, 2020, each of which is assigned to the assignee hereof, and each of which is expressly incorporated by reference in its entirety herein.

### BACKGROUND

The present disclosure concerns a filter for greenhouse or for outdoor cultivations adapted to improve energy saving during winter. The present disclosure also relates to a selective infrared filter apparatus comprising a first and a second foldable filter selectively actuable as a function of the season. The present disclosure also concerns a method for operating the selective infrared filter apparatus as well as a method for manufacturing a foldable screen.

### DESCRIPTION OF RELATED ART

Solar radiations are in the range from 300 nm to 2,500 nm of the solar spectrum. Solar radiations can be divided into ultraviolets from 300 to 400 nm, photosynthetic active radiations in the spectral range from 400 nm to 700 nm (the so-called PAR range), and non-photosynthetic radiation in the spectral range from 700 nm to 2,500 nm. Radiations up to 750 nm may also impact photosynthesis and plant morphogenesis. For instance, it has been demonstrated that the ratio between red (660 nm) and far-red (730 nm) has a significant impact on morphogenesis. We will therefore refer to extended photosynthesis radiation (ePAR) for radiations in the spectral range from 400 nm to 750 nm.

During summertime, the air temperature and air humidity in a greenhouse is not ideal for plant production; therefore, various techniques have been developed to improve temperature and humidity level. One technique includes shading the greenhouse to reduce the amount of energy transferred by the sun to the greenhouse. Different shading solutions have been imagined such as fix or dynamic solutions and selective or non-selective solutions.

Energy represents up to 40% of production cost in heated greenhouse which may be a concern for the environment and users. There are three type of thermal energy losses: convective, conductive and radiative losses.

Radiative heat loss explains a part of the energy loss, in particular during clear sky conditions (no clouds). Crop, soil and structure of the greenhouse radiates energy. In the usual winter temperatures (15° C.).+/−10°, the majority of the radiated energy is in the far infrared with wavelengths between 3′O00 and 50′000nm, with a peak between 5′O00 and 20,000nm. Some of this radiation can pass through the greenhouse cover and the atmosphere to reach the cosmos.

Some of the technologies developed to mitigate radiative heat loss have however significant drawbacks. In some technologies, low emissivity glass has been tried to reduce radiative heat loss. This technology well known for building is not appropriate for greenhouse because of high investment cost, significant light loss and higher temperature during summer times and a lower productivity.

Deployable screens made of aluminium strips have been developed to reduce radiative heat loss. However, such screens are mainly designed for shading application during summer. Because light needs to reach the plan, in some cases only 30 to 50% of the greenhouse surface can be covered with aluminium strips and a limited part of the radiation is reflected back inside the greenhouse. Moreover, these screens are usually not used during winter days as the light loss might be far too impactful.

Convective loss can be reduced by using “thermal screen.” Thermal screens may be deployed above the culture at critical moments. Such screens reduce light transmission by approximately 25% and therefore productivity. These screens are mainly used during the night, cloudy days with limited sunlight and when the temperature difference between the inside and the outside of the greenhouse is high. It is estimated that about 20% of energy saving can be achieved by using such screens.

Although current thermal screens reduce convective loss, such screens do not reduce efficiently heat radiative losses during winter.

An aim of the present disclosure is to provide a filter for greenhouse or for outdoor cultivations which obviates or at least mitigates the above disadvantages of the prior art.

In particular, an aim of the present disclosure to provide a filter for greenhouse or for outdoor cultivations, adapted to improve energy saving during winter by reducing convective and radiative loss

### SUMMARY

This main is achieved by means of a foldable screen for greenhouse or for outdoor cultivations, comprising:

a canvas;

a substrate on one side of the canvas, arranged for preventing convective heat transfer through the substrate and thus preventing or at least reducing conductive heat transfer through the screen;

at least one stack of films mounted on or adhering to said substrate, wherein said stack of film is adapted to
transmit at least 80% of radiations within the range from 400 nm to 2,500 nm when said radiations hit said film at normal incidence,
reject at least 70% of radiations at normal incidence within the range from 3000 nm to 35000 nm of the infrared spectrum.

The screen thus prevents convective heat loss and reduces radiative heat loss in the far infrared range, without shading the plants in the ePAR range.

The screen has a good transmittance in the near infrared range, for heating the greenhouse with infrared from the sun.

At least 80% of the sun radiations between 400 nm and 2,500 are thus transmitted.

This 80% transmittance within the range can be achieved even if the transmittance is lower than 80% for some wavelengths within that range.

In an example, the stack of film is adapted to
transmit a first percentage of radiations within the range from 400 nm to 750 nm, when said radiation hit said film at normal incidence, and
transmit a second percentage of radiation within the range from 850 nm to 2′000 nm,

wherein the first percentage is higher than the second percentage.

In an example, the stack of film is adapted to
transmit a first percentage of radiations within the range from 400 nm to 750 nm, when said radiation hit said film at normal incidence, and

1 transmit a second percentage of radiation within the range from 850 nm to 2′000 nm,

wherein the first percentage is at least 20% higher than the second percentage.

In an example, the first and second percentages are for example at least 90% and at least 60% respectively.

The first range is useful in order to make sure that the plants receive enough light in the ePAR range. The second range is useful for heating the greenhouse with solar radiations in the near infrared range.

In an example, at least 70%, preferably at least 80%, of the rejected radiations are rejected by reflection.

The at least one stack of thin films may comprise a conductive layer, a protective layer and an anti-reflective layer.

In an example, the conductive layer is a layer of metal selected from the group comprising silver, copper, aluminum and gold, wherein the conductive layer has a thickness of less than 15 nm, preferably less than 5 nm, or possibly between 5 and 15 nm

In an example, the conductive layer is a transparent conductive oxide (TCO) layer such as tin oxide, indium tin oxide or zinc tin oxide, wherein the conductive layer has a thickness from 20 nm to 200 nm.

In an example, the anti-reflective layer is a titanium dioxide (T1O2) layer or a silicon dioxide (SiC) layer.

In an example, said at least one stack of thin films faces cultivations when the screen is mounted in a greenhouse.

The substrate may be a polymer transparent within the spectral range from 400 nm to 2,500 nm, preferably between 400 nm and 15,000 nm.

The substrate may be for example polyethylene.

In an example, the at least one stack of thin films is encapsulated between two layers of polymers, wherein the layer of polymer which faces cultivations when the screen is mounted in a greenhouse, is absorbent within the spectral range from 2,500 nm to 15,000 nm, and preferably up to 35,000 nm, while the other layer of polymer, which faces the sky, is transparent within the range from 2,500 nm to 15,000 nm.

In an example, the substrate comprises down-conversion particles for re-emitting light radiation in a different wavelength.

In an example, the substrate has a thickness of no more than 50′000nm.

In an example, the canvas comprises a plurality of parallel strings when said foldable screen is in an unfolded configuration. The substrate may comprise a plurality of strips arranged transversally to said plurality of parallel strings.

A selective infrared filter apparatus for greenhouse comprising a first foldable screen as previously described, and a second foldable screen adapted to
reflect infrared radiations in the spectral range from 850 nm to 2000 nm, and
be transparent to radiations in the spectral range from 400 nm to 750 nm.

The second foldable screen may be used for protecting the plants from heat when the temperature in the greenhouse is too high.

The first and second foldable screen may be selectively unfolded or folded.

In an example, the selective infrared filter apparatus further comprises:
a first and a second actuable structure adapted to bring said first and second foldable screen respectively from a folded configuration to an unfolded configuration and vice-versa,
driving means (e.g., a driver) configured to actuate said first and second actuable structure,
at least one motor arranged to power the driving means (e.g., driver), and
a computer configured to control the driving means (e.g., driver) to selectively drive said foldable screen and foldable filtering film, wherein the driving means (e.g., driver) are controlled as a function of at least one parameter.

In an example, said at least one parameter is a delta temperature between a target temperature inside the greenhouse and the temperature outside the greenhouse.

In an example, the temperature outside the greenhouse is obtained from a first temperature sensor arranged outside the greenhouse and the temperature inside the greenhouse is obtained from a second temperature sensor, the first and second sensors being configured to send data to the computer.

Another aspect of the disclosure relates to a method of operating the selective infrared filter apparatus as described above. The foldable screen and foldable filtering film are selectively brought from a folded configuration to an unfolded configuration and vice a versa in order to regulate the temperature inside the greenhouse around a target temperature.

In an example, the method comprises
controlling the driving means (e.g., driver) to bring said foldable screen from a folded configuration to an unfolded configuration and to maintain or bring said filtering film from an unfolded configuration to a folded configuration, when a first condition is met, and
controlling the driving means (e.g., driver) to bring said foldable screen from an unfolded configuration to a folded configuration and to bring said foldable filtering film from a folded configuration to an unfolded configuration, when a second condition is met.

In an example, the first condition is met when the delta temperature between the target temperature inside the greenhouse and the temperature outside the greenhouse falls below a predetermined delta value, while the second condition is met when the delta temperature between the target temperature inside the greenhouse and the temperature outside the greenhouse exceeds said predetermined delta value.

### BRIEF DESCRIPTION OF THE DRAWINGS

The disclosure may be understood with the aid of the description of examples and illustrated by figures, in which:

FIG. 1 shows a greenhouse with one or a plurality of screens,

FIG. 2 shows strips of a film interlaced with a yarn framework,

FIG. 3 is a schematic view of a stack of films according to a first example.

FIG. 4 shows a simulation of the Transmission spectrum observed for: i) curve 1, a naked polyethylene film, ii) curve 2, a polyethylene film coated with a stack of copper (2 nm)/T1O2 (5 nm), iii) curve 3, a polyethylene film coated with a stack of ITO (120 nm) and iv) curve 4, a polyethylene film coated with a stack of ITO (120 nm)/S102 (130 nm).

### DETAILED DESCRIPTION

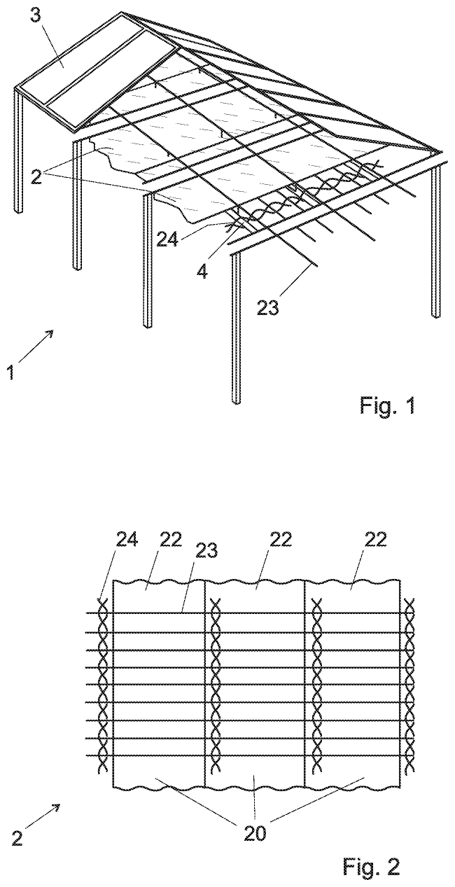

FIG. 1 shows a greenhouse 1 with a plurality of filters in the form of screens 2 or curtains, as well as a cable mechanism 4 used to fold or unfold the screens by pulling them across or aside. Contrary to a cladding 3 which is fixed, such as a glass cladding, a screen 2 can be moved to cover or uncover the crop under production. The screens 2 are designed to preserve the heat within the greenhouse by partially reflecting infrared radiation.

The screen is also a “thermal screen” and therefore designed to reduce or preferably suppress the exchange rate of air from one side of the filter and the other side, thus preventing or at least reducing convective heat loss.

In the example of FIG. 1, each screen 2 comprises a plurality of strips 20 which are, in the example, adjacent so that air cannot flow between the strips, thus preventing air transfer. Spaced apart strips 22 may also be used if a limited heat or humidity transfer is desired. The strips may comprise a substrate, and be mounted onto a canvas, such as a yarn framework 21 with textile or polymer threads 23. The threads 23 are preferably running parallel to each other and spaced apart so that they do not shade the cultures. Several threads might be connected between the strips with threads running in an orthogonal direction.

Each strip 20 comprises a substrate such as a polymer film 22 on at least one side of this fabric, and at least one stack of films that provide the filtering function and that are mounted on or adhering to the polymer film 22. The strips are mounted onto the canvas 21.

The polymer substrate is preferably transparent in the range between 400 and 30′000nm. The substrate may be a polyester substrate. The substrate may be a polyethylene substrate.

A material is said to be transparent in a range when at least 70%, preferably at least 80% of the radiation at normal incidence at each wavelength within that range is transmitted through the material. A material is said to be reflective in a range when at least 70%, preferably at least 80% of the radiation at normal incidence at each wavelength within that range is reflected by the material.

The canvas 21 maintains the strips together. It prevents air to flow through the screen but allows the transfer of solar and thermal radiations. The canvas also allows water vapor to pass through the screen.

FIG. 2 shows a screen inside a greenhouse and the cable mechanism used to pull it across or aside is shown.

In an example, the strips/yarn of the foldable screen are made from a polymer coated with a stack of films designed to:
reject a significant (>70%, preferably at least 80%) part of the radiations in the spectral range from 3000 nm to 50′000 nm and above,
transmit a significant (>90%) part of the radiations in the ePAR range and preferably >60% in the [400-2,500 nm] range.

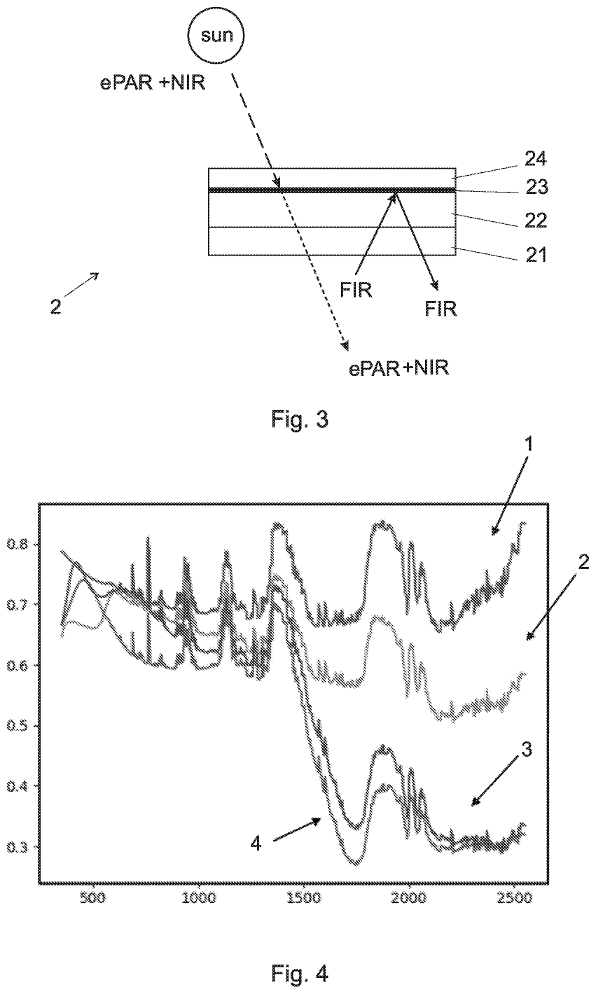

In the first example shown on FIG. 3, the filter 2 comprises a substrate 22 mounted onto a canvas 21 and onto which a stack of films 23 is coated. Optionally, a protective layer 24 may cover the stack of films 23 from mechanical or chemical aggressions.

The stack of films 23 may comprise at least one film of metal, such as copper, deposited on the polymeric substrate. In one example, the stack of films comprises a copper layer with a thickness of about less than 15 nm, for example 2 nm and T1O2 layer with a thickness of about 5 nm deposited on the polymeric substrate 22.

The T1O2 layer acts as an anti-reflective layer increasing the transmission in the ePAR range.

This example allows the production of foldable screen at low cost. It also allows the production of an efficient filter with a limited amount of material (copper and T1O2) to coat the film.

The stack of films described above has also the advantage to be transparent in the ePAR spectrum and to have good reflectivity properties in the thermal far infrared after 8′000 nm.

Absorption may occur as well due to the metallic nature of the film but will be limited to for instance 10% and no more than 30% of rejected radiations depending on the material used in the different layers and their thickness.

In some examples, the stack of films may comprise a transparent conductive oxide (TCO) layer such as tin oxide, Indium tin oxide (ITO) or Zinc tin Oxide (ZTO).

A protective layer may be added as well as an anti-reflective layer such as S1O2 layer with the aim to reduce the difference of refraction index between the air and the stack. For instance, by coating a layer of ITO with a thickness of about 120 nm on a Polyethylene (PE) substrate and a layer of SiO2 with a thickness of about 130 nm on top of the ITO layer as an anti-reflective layer, a film is obtained which allows transmission therethrough of 70% of the radiations in the ePAR spectrum and as much as 60% of the NIR while such film reflects 70% of the thermal far infrared.

Manufacturing such a film may be easy and well mastered but the amount of expensive material used may be considered as compared to the first example, hence the cost of production may be significantly higher.

In both examples, the coating is preferably on the inner side of the substrate (i.e. the side that will face the crop under production. An additional layer of polymer substrate 24 may be added in a way that the coating is in sandwich between the two polymer substrates. This additional protective substrate 24 has to be transparent to thermal far infrared (5,000 to 15,000nm, preferably 5,000 to 20,000 nm) which is for instance the case of polyethylene (PE).

The screen may be manufactured according to different manufacturing processes. In an example, the film is cut in strips to be incorporated in a yarn framework to form a screen. The film used for the strips has to be thin enough to be compatible with current production process and later facilitate the folding and unfolding of the screen. The strips may for example have a thickness of about 20 to 50 microns but no more than 200 microns. The polymer substrate is selected according to its optical and mechanical properties such as spectral transfer function, UV resistance, flame retardant and compatibility with greenhouse/outside environment.

In an example, down-conversion additives can be incorporated to the substrate. Different pigments organic or inorganic like: quantum dots, phosphorous pigments have the property to absorb light in a given range of wavelength and emit light in another higher range of wavelength.

In an example, the film is manufactured using a spatial atomic layer deposition (SALD) in a roll-to-roll configuration. In another example, the polymer substrate is held for example on a roll and unwound from said roll. In a first treatment step, the substrate is heated to remove the non-volatile components. Then the next step is the coating per se with the desired thin film layers. This can be done using different technologies, for example by sputtering, e.g. DC sputtering or RF sputtering. The choice may depend on the material being deposited for the coating. For example, for Indium Tin Oxide (ITO), a DC sputtering may be used, for S1O2 a RF sputtering may be used.

After the coating step, an additional layer of polymer may be added through lamination above the stack of thin films, then the film is again wound on a roll for future use or process steps. Additional steps may comprise measurements means, such as optical means, to control the deposited layers and their thickness or quality.

The film roll is then unwound to be cut in strips that will be incorporated in line in the yarn framework in the screen manufacturing process. To cut the strips, an ultrasonic device or alternatively a laser will be used to cauterize the lateral edges of the strips by melting the substrate, thereby offering a better protection against greenhouse/outside environment and preventing air water vapor to alter the different thin films.

The strips may be cut using for instance a state-of-the-art ultrasonic device that will make possible to cover the lateral edges of the strips by melted polymer from the substrate, thereby preventing water vapor to contaminate the stacks once the strips are incorporated in the screen and places in a humid environment.

The deployment of the foldable screen may be controlled by a computer. At least two temperature sensors: one inside and one outside the greenhouse are configured to provide temperature measurements to a computer program running on the computer. At least two PAR sensors, one inside and one outside the greenhouse, are configured to provide continuous measurements of the PAR inside and outside the greenhouse. One pyrometer placed inside the greenhouse/shade house is configured to provide continuous measurements of received thermal infrared and then measure sky clarity.

The computer program is configured to operate the deployment of the foldable screen as follows:

If the difference of temperatures inside and outside the greenhouse is superior to a cloudy temperature setpoint, and the sky is cloudy, and the solar radiations are inferiors to a cloudy light setpoint, the screen is brought to a folded configuration.

If the difference of temperatures inside and outside the greenhouse is inferior to the cloudy temperature setpoint, and the sky is cloudy, and the solar radiations are inferiors to the cloudy light setpoint, the screen is brought to an unfolded configuration.

If the difference of temperatures inside and outside the greenhouse is superior to a clear sky temperature setpoint, and the sky is clear, and the solar radiations are superiors to a clear sky temperature setpoint, the screen is brought to an unfolded configuration.

1. A foldable screen for greenhouse or for outdoor cultivations, comprising:
a canvas;
a substrate on one side of the canvas, arranged for preventing convective heat transfer through the foldable screen;
at least one stack of films mounted on or adhering to the substrate, wherein the at least one stack of films is adapted to:
transmit at least 80% of radiations within a range from 400 nm to 2,500 nm when radiation hits the at least one stack of films at normal incidence,
reject at least 70%, preferably at least 80% of radiations at normal incidence within the range from 3,000 nm to 35,000 nm.

2. The foldable screen of claim 1, wherein the at least one stack of films is adapted to:
transmit a first percentage of radiations within the range from 400 nm to 750 nm, when radiation hits the at least one stack of films at normal incidence, and
transmit a second percentage of radiation within the range from 850 nm to 2,000 nm,
wherein the first percentage is higher than the second percentage, the first and second percentages being at least 90% and at least 60% respectively.

3. The foldable screen of claim 2, wherein the at least one stack of films is arranged so that the second percentage of radiation is at least 70%.

4. The foldable screen of claim 1, wherein the at least one stack of films comprises a conductive layer, a protective layer, or an anti-reflective layer, or any combination thereof.

5. The foldable screen of claim 4, wherein the conductive layer is a layer of metal selected from a group comprising silver, copper, aluminum and gold, wherein the conductive layer has a thickness of less than 15 nm.

6. The foldable screen of claim 4, wherein the conductive layer is a transparent conductive oxide (TCO) layer such as tin oxide, indium tin oxide or zinc tin oxide, wherein the conductive layer has a thickness from 20 nm to 200 nm.

7. The foldable screen of claim 4, wherein the anti-reflective layer is a titanium dioxide (T1O2) layer or a silicon dioxide (S1O2 ) layer.

8. The foldable screen of claim 1, wherein the at least one stack of films faces cultivations when the foldable screen is mounted in a greenhouse and wherein the substrate is a polymer transparent to radiation within the range from 400 nm to 2,500.

9. The foldable screen of claim 1, wherein the at least one stack of films is encapsulated between two layers of polymers, wherein a layer of polymer which faces cultivations when the foldable screen is mounted in a greenhouse, is absorbent within the range from 2,500 nm to 15,000 nm while an other layer of polymer, which faces the sky, is transparent within the range from 2,500 nm to 15,000 nm.

10. The foldable screen of claim 1, wherein the substrate comprises down-conversion particles.

11. The foldable screen of claim 1, wherein the substrate has a thickness of no more than 50,000 nm.

12. The foldable screen of claim 1, wherein the canvas comprises a plurality of parallel strings when the foldable screen is in an unfolded configuration, and wherein the substrate comprises a plurality of strips arranged transversally to the plurality of parallel strings.

13. A selective infrared filter apparatus for greenhouse comprising:
a first foldable screen, and
a second foldable screen adapted to:
reflect infrared radiations in the range from 850 nm to 2,000 nm, and
be transparent to radiations in the range from 400 nm to 750 nm.

14. The selective infrared filter apparatus of claim 13, further comprising:
a first and a second actuable structure adapted to bring the first foldable screen and the second foldable screen respectively from a folded configuration to an unfolded configuration and vice-versa,
driver configured to actuate the first and second actuable structure,
at least one motor arranged to power the driver, and
a computer configured to control the driver to selectively drive the first foldable screen and the second foldable screen, wherein the driver is controlled as a function of at least one parameter.

15. The selective infrared filter apparatus of claim 13, wherein the first foldable screen and the second foldable screen are selectively brought from a folded configuration to an unfolded configuration and vice-versa in order to regulate a temperature inside the greenhouse around a target temperature.
